(19) United States
(12) Patent Application Publication
(10) Pub. No.: US 2005/0005285 A1
(43) Pub. Date: Jan. 6, 2005

(54) Method of protecting light sensitive optical article

(75) Inventors: Daniel Robert Olson, Voorheesville, NY (US); Marc Brian Wisnudel, Clifton, NY (US)

Correspondence Address: General Electric Company;CRD Patent Docket Rm 4A59, Bldg. K-1, P.O. Box 8, Schenectady, NY, 12301, US

(73) Assignee: General Electric Company

(21) Appl. No.: 10/612,751

(22) Filed: Jul. 3, 2003

(51) Int. Cl. G11B 3/70; G11B 5/84; G11B 7/26

(52) U.S. Cl. 720/719

(57) ABSTRACT

Disclosed herein is a method of protecting a light sensitive optical article. The protection can be achieved by contacting the surface of the optical article to be protected with the surface of a protective film comprising a polymer and at least one light absorbing compound selected from the group consisting of UV-vis absorbers and a yellow dyes. Alternatively the light sensitive optical article can be inserted in an enclosure made by the protective plastic film.

### BACKGROUND OF THE INVENTION

This invention relates to a method of protecting a light sensitive optical article. More particularly the method of the present invention relates to limited play storage media.

Optical, magnetic and magneto-optic media are primary sources of high performance storage technology which enable high storage capacity coupled with a reasonable price per megabyte of data stored. The use of optical media has become widespread in audio, video, and computer data storage applications in such formats as compact disc (CD), digital versatile disc (DVD, including multi-layer structures like DVD-5, DVD-9 and multi-sided formats such as DVD-10, and DVD-18), magneto-optical disc (MO), and other write-once and re-writable formats such as CD-R, CD-RW, DVD-R, DVD-RW, DVD+RW, DVD-RAM, and the like, hereinafter collectively “data storage media”. In these formats, data are encoded onto a substrate into a digital data series. In pre-recorded optical media, such as CD, the data are typically pits and grooves embossed on the surface of a plastic substrate using a method such as injection molding, stamping or the like.

In some applications, it is desirable to limit the playable lifetime of an optical disc. For example, there is widespread interest in providing temporary access to music, movies, and other forms of digital entertainment without requiring a purchaser to return a data storage device to its provider. Put in very concrete terms, a customer purchasing a movie on a limited play DVD would be granted only limited access to the movie because by design, access to the data contained within the limited play DVD would be extinguished over a relatively short period of time after its first use. Recycling concerns raised by such limited use schemes are balanced by the both recyclability of the limited play DVD itself and the elimination of at least one trip, typically in an automobile, to the site of the DVD's purchase.

Thus, a need exists for machine-readable optical discs which provide limited access to music, movies, other forms of digital entertainment, or any other data for which limited access is appropriate, wherein said optical discs do not need to be returned to the provider at the end of a limited period of access. Limited-play optical discs provide a solution to this problem.

Limited play discs such as DVD's have been produced by various methods. One method includes forming a disc comprising a reflective layer protected by a porous barrier layer such that the reflective layer becomes oxidized over a predetermined period of time. Once the reflective layer attains a certain level of oxidation, the disc is no longer readable.

Currently, limited-play DVDs are available which extinguish access to data embedded within them by a darkening process which prevents the data from being read by a laser. In some instances it has been found that the darkening process may take place prematurely or in an otherwise uncontrolled manner. For example, in some instances where access to the data comprised within a DVD is limited by darkening caused by exposure of the surface of the DVD to atmospheric oxygen, it has been discovered that one or more oxygen sensitive components of the limited play DVD may also be highly sensitive to ambient light. Under such circumstances, the predicted limited use period based on oxygen exposure may be shortened dramatically by exposure of the limited play DVD to ambient light, for example sunlight, which results in a premature darkening of the DVD rendering it unplayable. Such loss of control over the limited period of access to data contained within the DVD severely limits its value. Moreover, where the limited period of access is predicated on light sensitivity of the DVD alone, steps must be taken to prevent exposure of the DVD to light of harmful wavelengths at least until the limited period of access is initiated, such that the DVD remains fully playable during the limited period of access.

In view of the forgoing, there exists a need to provide protection for light sensitive optical articles, such as limited poly DVDs, from uncontrolled abridgement of the useful lifespan of the optical articles. The present invention provides novel solutions to these and allied problems as evidenced by the description, examples and claims which follow.

### BRIEF SUMMARY OF THE INVENTION

In one aspect, the present invention provides a method of protecting a light sensitive optical article, said method comprising a first step,
Step (A) comprising obtaining a plastic protective film, said film having two film surfaces, said film comprising at least one light absorbing compound selected from the group consisting of UV-Visible absorbers and yellow dyes;
   and a second step selected from the group consisting of
Step (B) contacting one of said film surfaces with the optical article to be protected thereby providing an optical article in contact with a removable protective film; and
Step (C) forming an enclosure comprising said protective film and inserting the optical article to be protected therein.

In another aspect, the present invention relates to a protected light sensitive optical article made by the method of the present invention.

### DETAILED DESCRIPTION OF THE INVENTION

The present invention may be understood more readily by reference to the following detailed description of preferred embodiments of the invention and the examples included herein. In this specification and in the claims which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein the term “polycarbonate” refers to polycarbonates incorporating structural units derived from one or more dihydroxy aromatic compounds and includes copolycarbonates and polyester carbonates.

As noted, the present invention provides a method of protecting a light sensitive optical article. In one embodiment of the invention a plastic protective film is obtained and contacted directly with the light sensitive optical article to provide a protected light sensitive optical article in contact with a removable protective film. In an alternate embodiment of the present invention a plastic protective film is obtained and used to form an enclosure comprising the protective film, and the light sensitive optical article is inserted into the enclosure thereby protecting it. In another embodiment the enclosure is closed or sealed to prevent exposure of the light sensitive optical article to light.

Light sensitive optical articles which may be protected by the method of the present invention include DVD's, optical lenses, prisms, optical windows, optical wires, optical switches, optical wave guides, optical displays, light emitting diodes, optical data storage devices, and the like. The method of the present invention is particularly well suited for the protection of “limited-play” optical data storage devices such as limited-play DVD's and like limited-use home entertainment devices.

The plastic protective film used according to the method of the invention comprises at least one light absorbing compound. Such plastic protective films may be obtained commercially or prepared using known polymer compounding and film forming techniques. Suitable light absorbing compounds include UV-visible absorbers, yellow dyes, and mixtures thereof. Typically, the protective film comprises at least one light absorbing compound selected from the group consisting of UV-visible absorbing compounds, yellow dyes, and mixtures of UV-visible absorbing compounds and yellow dyes

UV-visible absorbers include hydroxybenzophenones, benzotriazoles, cyanoacrylates, triazines, oxanilide derivatives, poly(ethylene naphthalate), formamidines, cinnamates, malonate derivatives and mixtures thereof.

Specific examples of UV-visible absorbers which may be used according to the method of the present invention include 2-(2′-hydroxy-5′-methylphenyl)benzotriazole; 2-(3′-tert-butyl-2′-hydroxy-5′-methylphenyl)-5-chlorobenzotriazole; 2-(3′,5′-di-tert-butyl-2′-hydroxyphenyl)-5-chlorobenzotriazole; 2,2′-dihydroxy-4,4′-dimethoxybenzophenone; 2-(4,6-diphenyl-1,3,5-triazin-2-yl)-5-(hexyloxy)-phenol; 2-(4,6-bis(2,4-dimethylphenyl)-1,3,5-triazin-2-yl-5-octyloxy)phenol; 2-(2′-hydroxy-5′-methylphenyl)benzotriazole; 2,4-dihydroxybenzophenone; 2,4,2′,4′-tetrahydroxybenzophenone; 2-hydroxy-4-ocytyloxybenzophenone; 2-hydroxy-4-methoxybenzophenone; and mixtures thereof.

As noted, the plastic protective film may comprise a light absorbing compound which is at least one yellow dye. The yellow dyes are typically selected from the group consisting of monoazo derivatives, bisazo derivatives, quinoline derivatives, xanthene derivatives and combinations thereof. Yellow dyes suitable for use according to the method of the present invention include color index disperse yellow 54, color index disperse yellow 201, color index pigment yellow 138, color index 11020 methyl yellow, color index 11855 disperse yellow 3, color index 13065 metanil yellow, color index 13900 acid yellow 99 and other acid yellow dyes, color index 13920 direct yellow 8 and other direct yellow dyes, color index 14025 alizarin yellow, GG color index 14045 mordant yellow 12, color index 15985 sunset yellow FCF, color index 24890 brilliant yellow, color index 46025 acridine yellow G, 3-carboxy-5-hydroxy-1-p-sulfophenyl-4-p-sulfophenylazopyrazole trisodium salt (yellow dye #5), and 1-(sulphophenylazo)2-napthol-6-sulphonic acid disodium salt (yellow dye #6). Such yellow dyes are available commercially or may be made by means well known in the art.

The plastic protective film may be any thermoplastic known in the art, such as polyvinyl chloride, polyolefin homopolymers and copolymers, polyesters, polyurethanes, polyamides, polysulfones, polyimides, polyetherimides, polyphenylene ethers, polyphenylene sulfides, polyether ketones, polyether ether ketones, acrylonitrile-butadiene-styrene (“ABS”), polyethersulfones, poly(alkenylaromatic) polymers, polybutadiene, acrylic polymers, polyacrylonitrile, polyacetals, polycarbonates, ethylene-vinyl acetate copolymers, ethylene-vinyl alcohol copolymers, polyvinyl acetate, liquid crystal polymers, ethylene-tetrafluoroethylene copolymer, aromatic polyesters, polyvinyl fluoride, polyvinylidene fluoride, polyvinylidene chloride, tetrafluoroethylene, and combinations comprising the foregoing resins. Mixtures of different polymers, such as polyphenylene ether/styrenic blends, polyvinyl chloride/ABS or other impact modified polymers, such as methacrylonitrile and alpha-methylstyrene containing ABS, and polyester/ABS or polycarbonate/ABS and polyester plus some other impact modifier may also be used. Such polymers are available commercially or may be made by means well known in the art.

Polyesters suitable for use as the plastic protective film include, poly(ethylene terephthalate), poly(butylene terephthalate), and poly(ethylene-co-1,4-cyclohexylenedimethylene terephthalate).

In certain embodiments, the plastic protective film comprises at least one polyamide selected from the group consisting of crystalline and amorphous nylons, for example nylon 4, nylon 6, nylon 6,6; nylon 7, nylon 8, nylon 9, nylon 11, nylon 12, nylon 4,2; nylon 4,6; nylon 4,1; nylon 6,9; nylon 6,10; nylon 6,11; nylon MXD6, nylon 6,12; nylon 6,6,6; nylon 6,6/61; nylon 6,6,6T; nylon trimethyl 6,2/6,2; and nylon 6,6/6,9/6.

In another embodiment the protective film comprises a polyolefin selected from the group consisting of polyethylene, polypropylene, polybutylene, and mixtures thereof.

Typically, the uv-visible absorber is present in an amount corresponding to between about 0.1 percent and about 5 percent by weight based on the total weight of the composition comprising the plastic protective film. In one embodiment, the UV-visible absorber is present in an amount corresponding to between about 0.2 percent and about 4 percent by weight based on the total weight of the composition comprising the plastic protective film. In an alternative embodiment, the UV-visible absorber is present in an amount corresponding to between about 0.5 percent and about 3 percent by weight based on the total weight of the composition comprising the plastic protective film.

Typically, the plastic protective film has a thickness in the range between about 0.5 mil and about 100 mil and transmits light less than about 10 percent of incident light having a wavelength between about 300 nm and about 450 nm. In certain embodiments the thickness of the plastic protective film is in a range between about 0.5 mil and about 50 mil and transmits light less than about 1 percent of incident light having a wavelength between about 300 nm and about 450 nm. In other embodiments of the invention the plastic protective film has a thickness in a range between about 0.5 mil and about 50 mil and transmits less than about one percent of incident light having a wavelength between about 315 nm and about 400 nm.

In one embodiment of the present invention the plastic protective film is contacted with the light sensitive optical article such that although the film and the optical article are in intimate contact, the film is removable. What is meant by “removable” is that the film may be readily peeled or torn away from the optical article. Thus a plastic protective film having two surfaces is contacted with a light sensitive optical article in such a way that one surface of the film adheres to the surface of the optical article. When the film in contact with the optical article is characterized as “removable”, it simply means that the adhesive forces between the film and the optical article are easily overcome and the film may be manually peeled or torn away from the optical article without damage to the optical article.

In one embodiment, the optical article and protective film are contacted by applying a pressure sensitive adhesive to one surface of a plastic protective film having two surfaces, and then bringing the optical article into contact under a positive pressure with the pressure sensitive adhesive. The pressure-sensitive adhesive may be water-based such as acrylic, vinyl acrylic, styrene acrylic, urethane acrylic, butyl acrylate and other acrylic emulsions or cross-linked alkyl acrylic esters, rubber-based adhesives such as those based on styrene-butadiene-styrene copolymers, epoxides, silicone-based adhesives such as blends of silicone resin with polydiorganosiloxane. Water-based acrylic polymer emulsion pressure sensitive adhesive suitable for use according to the method of the present invention include Gelva GME 2234 from Solutia, 72.9292 from National Starch & Chemical Co., and Phoplex N-500 from Rohm & Haas Co. Solvent-based pressure sensitive adhesives suitable for use according to the method of the present invention include Gelva GMS 1753 from Solutia, and Durotak 80-1058 from National Starch & Chemical, and mixtures thereof.

Water-based and solvent-based liquid pressure sensitive adhesives can be applied to a moving web of plastic protective film using standard coating methods including Meyer rod, gravure, knife over-roll, and 3 and 4-roll reverse roll coating to form an adhesive coated plastic protective film. Typically, the pressure sensitive adhesive-coated plastic protective film is then dried, cut into an appropriate size and shape, and then contacted with the surface of the light sensitive optical article. The resulting sandwich structure comprising the plastic protective film, pressure sensitive adhesive and the light sensitive optical article may then be passed through a laminator to ensure good adhesion of the plastic protective film to the light sensitive optical article. In one embodiment the pressure sensitive adhesive-coated plastic protective film is laminated to a silicone coated backer to protect the pressure sensitive adhesive. Then, in application, the backer will be removed to expose the pressure sensitive adhesive and the light sensitive optical article to be protected is applied to adhere to the film.

The plastic protective film may also be coated or otherwise deposited directly onto the surface of the light sensitive optical article to be protected. The plastic protective film may be coated onto the surface of the light sensitive optical article using any of a number of techniques including painting, spraying, spin-coating, dipping, screen-printing and the like. For example, in one embodiment where the light sensitive optical article is a light sensitive optical data storage disc, the plastic protective film is dissolved in a relatively volatile organic solvent, said solvent being substantially inert towards the light sensitive optical data storage disc (meaning that the solvent will not attack or otherwise adversely affect the light sensitive optical data storage disc), and the solution of the protective film is applied directly to the surface of the light sensitive optical article. Generally, the concentration of the plastic protective film in the solvent is greater than about 5 weight percent and less than about 25 weight percent, and preferably greater than about 10 weight percent and less than about 20 weight percent.

Suitable organic solvents for use with solvent-borne films include ethylene glycol diacetate, butoxyethanol, methoxypropanol, the lower alkanols, and the like. Generally, the concentration of the solvent in the coating solution is about 70 weight percent or greater, with about 75 weight percent or greater preferred.

In one embodiment the plastic protective film may also optionally contain various additives such as flattening agents, surface active agents, thixotropic agents, and the like, and reaction products and combinations comprising at least one of the foregoing additives.

The thickness of the plastic protective film is dependent upon the particular light sensitive component employed, the concentration thereof in the plastic protective film, and the desired absorption characteristics of the film both initially and after a desired period of time. In the case of a plastic protective film coated onto the light sensitive optical article to be protected, the film typically has a thickness in a range between about 1 micron (μ) and about 15μ, preferably between about 2μ preferred and about 10μ, and still more preferably between about 3μ and about 6μ.

In an alternate embodiment of the present invention an enclosure comprising the protective film is obtained and the light sensitive optical article is simply inserted into the enclosure thereby protecting the light sensitive optical article from light. The enclosure may be a rigid three dimensional structure made entirely of the protective film, a rigid three dimensional structure comprising other materials in addition to the protective film, for example a three dimensional container comprising an accessible inner cavity in which to place the light sensitive optical article and an outer surface to which adheres a protective film comprising at least one light absorbing compound selected from the group consisting of UV-Visible absorbers and yellow dyes.

In an alternate embodiment the enclosure comprising the protective is a pouch or bag. The pouch or bag may be of a type which may be sealable. Suitable means for sealing the enclosure include a zipper-type means, thermal means or adhesive means. In one embodiment of the present invention the enclosure comprising the protective film is of the “sandwich bag” type. Alternatively the enclosure may be formed by wrapping a flexible sheet comprising the protective film around the light sensitive optical article in much the same manner as one would wrap a gift such that the enveloping wrapping fully shielded the light sensitive optical article from light. The protective film may be decorative and include various colors and patterns.

In one embodiment, the light sensitive optical article to be protected comprises a colorant or combination of colorants. The colorant is typically present in a range between about 0.00001 weight % and about 2 weight %, more typically, in a range between about 0.001 weight % and about 1 weight %, and most typically, in a range between about 0.01 weight % and about 0.5 weight %, based on the total weight of the light sensitive optical article. The colorant is preferably soluble in the material used to form the light sensitive optical article in which the colorant is disposed. Where the light sensitive optical article is a limited-play DVD comprising a polycarbonate layer, colorants that are soluble in the polycarbonate layer are preferred. These polycarbonate-soluble colorants include dyes, for example solvent dyes, organic colorants, pigments, and the like, which behave like dyes. Typically, it is preferred that the colorant fully disperse in the plastic and that the colorant does not form aggregates having a size greater than about 200 nm, with an aggregate size less than or equal to about 50 nm being preferred. Some suitable colorants include, but are not limited to, those of the chemical family of anthraquinones, perylenes, perinones, indanthrones, quinacridones, xanthenes, oxazines, oxazolines, thioxanthenes, indigoids, thioindigoids, naphtalimides, cyanines, xanthenes, methines, lactones, coumarins, bis-benzoxaxolylthiophenes (BBOT), napthalenetetracarboxylic derivatives, monoazo and diazo pigments, triarylmethanes, aminoketones, bis(styryl)biphenyl derivatives, and the like, as well as combinations comprising at least one of the foregoing colorants.

### EXAMPLES

The following examples are set forth to provide those of ordinary skill in the art with a detailed description of how the methods claimed herein are carried out and evaluated, and are not intended to limit the scope of what the inventors regard as their invention.

Limited-play digital versatile discs (DVDs) were obtained from Flexplay Technologies, Inc. LEXAN MR10 sheet was provided by GE Plastics. Transparent UV absorbing polyester film (item no. E39-426) was obtained from Edmund Industrial Optics. The 420 nm Schott GG420 cutoff filter (item no. NT46-427) was obtained from Edmund Industrial Optics. CRYOVAC bags were obtained from Cryovac Sealed Air Corporation.

### Example 1

A limited-play digital versatile disc (DVD) which had not previously been exposed to light was tested on a PROmeteus MT136E optical disc scanner available from Dr. Schenk GmbH and was found to have a reflectivity value of 72% and was fully playable on a commercial DVD player. In general, a DVD having a measured reflectivity value of about more than about 20% preferably the measured reflectivity value is of about more than 45% is generally considered playable on a commercial DVD player. The DVD was then positioned directly under a 150 watt halogen lamp at a distance of 6 inches. A ⅛ inch thick sheet of a plastic protective sheet (LEXAN MR10) having an absorbance of greater 3 from the range between 250 nm to about 395 nm was laid on top of the DVD in such a way that the protective film completely covered the DVD. The halogen lamp was then switched on. Reflectivity measurements on the DVD were made after 1.5 hours and 5 hours of exposure of the DVD-protective film assembly to the light generated by the halogen lamp. After 1.5 hours the DVD exhibited a reflectivity of 51 percent. After 5 hours the DVD exhibited a reflectivity of 39 percent.

### Examples 2-5

Examples 2-5 were carried out as in Example 1 except that the protective film employed was either a 420 nm cutoff filter (Example 2), a transparent UV absorbing polyester film (Example 3), or a combination of a transparent UV absorbing polyester film and a CRYOVAC bag (Example 4). In Example 4 the DVD and the transparent UV absorbing polyester film were placed inside a CRYOVAC bag, the transparent UV absorbing polyester film being positioned between the DVD and the halogen lamp.

In Example 5, the UV absorbing polyester film was affixed to the DVD with spray adhesive with the UV absorbing polyester film being positioned between the DVD and the halogen lamp. In that example, the reflectivity remained essentially unchanged for a period of 5 in hours in which the UV absorbing film was affixed to the DVD. The UV absorbing film was then removed and the DVD was then re-exposed to the halogen lamp. After 1.5 hours of light exposure, the reflectivity decreased to 38% and after 3 hours, the reflectivity decreased to 15%.

### Comparative Examples 1-2

Comparative Examples 1-2 were carried out as in Example 1 except that no protective film was employed. In Comparative Example 1 the DVD was exposed directly to the halogen lamp. In Comparative Example 2 the DVD was placed in a CRYOVAC bag prior to exposure to the halogen lamp.

Data for Examples 1-5 and Comparative Examples 1-2 are gathered in the Table and demonstrate the effectiveness of the plastic protective films in preserving DVD reflectivity and the sensitivity of the limited play DVD's to the light source.

| | | TABLE | | |
|---|---|---|---|---|
| | | Elapsed Time | | |
| | | (hours)^{a} and | | |
| | | % Reflectivity^{b} | | |
| Example No. | Plastic Protective Film | 0^{a} | 1.5^{a} | 5^{a} |
| Example 1 | LEXAN MR10 Sheet | 72^{b} | 51^{b} | 39^{b} |
| Example 2 | 420 nm Cutoff Filter | 70^{b} | — | 45^{b} |
| Example 3 | UV Absorbing polyester film | 72^{b} | 72^{b} | 69^{b} |
| Example 4 | UV Absorbing polyester film and | 72^{b} | 69^{b} | 67^{b} |
| | CRYOVAC bag | | | |
| Example 5 | UV Absorbing polyester film | 73^{b} | 71^{b} | 71^{b} |
| | affixed to DVD by adhesive | | | |
| Comparative | None | 72^{b} | 38^{b} | <1^{b} |
| Example 1 | | | | |
| Comparative | None, CRYOVAC bag | 72^{b} | 52^{b} | <1^{b} |
| Example 2 | | | | |

^{a}Elapsed time in hours
^{b}% reflectivity measured

The invention has been described in detail with particular reference to preferred embodiments thereof, but it will be understood by those skilled in the art that variations and modifications can be effected within the spirit and scope of the invention.

1. A method of protecting a light sensitive optical article, said method comprising a first step (A),
Step (A) comprising obtaining a plastic protective film, said film having two film surfaces, said film comprising at least one light absorbing compound selected from the group consisting of UV-Visible absorbers and yellow dyes;
and a second step selected from the group consisting of
Step (B) contacting one of said film surfaces with the optical article to be protected thereby providing an optical article in contact with a removable protective film; and
Step (C) forming an enclosure comprising said protective film and inserting the optical article to be protected therein.

2. The method according to claim 1, wherein said light sensitive optical article is selected from the group consisting of a DVD, an optical lens, a prism, an optical window, an optical wire, an optical switch, an optical wave guide, an optical display, and a light emitting diode.

3. The method according to claim 1, wherein said protective film transmits less than about 1 percent incident light having a wavelength between about 300 and about 450 nm.

4. The method according to claim 3, wherein said film has a thickness in a range between about 0.5 mil and about 100 mil.

5. The method according to claim 1, wherein said UV-visible absorber is selected from the group consisting of hydroxybenzophenones, benzotriazoles, cyanoacrylates, triazine, oxanilide derivatives, formamdines, cinnamates, malonate derivatives and combinations thereof.

6. The method according to claim 1, wherein said yellow dye is selected from the group consisting of 3-carboxy-5-hydroxy-1-p-sulfophenyl-4-p-sulfophenylazopyrazole trisodium salt, disodium salt of 1-(sulphophenylazo)-2-napthol-6-sulphonic acid), monoazo derivatives, bisazo derivatives, quinoline derivatives, xanthene derivatives and combinations thereof.

7. The method according to claim 1, wherein said plastic protective film is selected from the group consisting of polyvinyl chloride, polyolefins, polyesters, polyurethanes, polyamides, polysulfones, polyimides, polyetherimides, polyphenylene ethers, polyphenylene sulfides, polyether ketones, polyether ether ketones, ABS resins, polyethersulfones, poly(alkenylaromatic) polymers, polybutadiene, acrylic polymers, polyacrylonitrile, polyacetals, polycarbonates, polyphenylene ethers, ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, tetrafluoroethylene, and combinations comprising the foregoing resins.

8. The method according to claim 1, wherein said light absorbing compound is present at a level between 0.1 and about 5 percent by weight based on the total weight of said plastic protective film.

9. The method according to claim 1, wherein said contacting comprises applying an adhesive layer to one of two said film surfaces and thereafter joining the film to the light sensitive optical article such that the light sensitive optical article is in contact with said adhesive layer.

10. The method according to claim 9, wherein said adhesive layer comprises at least one adhesive material selected form the group acrylic, vinyl acrylic, styrene acrylic, urethane acrylic, butyl acrylate, acrylic emulsions, cross linked alkyl acrylic esters, rubber based adhesives selected from styrene-butadiene-styrene, epoxides, silicone based, silicone resins and combinations thereof.

11. A method of protecting a light sensitive limited use optical data storage device, said method comprising a first step,
Step (A) comprising obtaining a plastic protective film, said film having two film surfaces, said film comprising at least one light absorbing compound selected from the group consisting of UV-Visible absorbers and yellow dyes;
and a second step selected from the group consisting of
Step (B) contacting one of said film surfaces with the optical data storage device to be protected thereby providing a limited use optical data storage device in contact with a removable protective film; and
Step (C) forming an enclosure comprising said protective film and inserting the limited use optical data storage device to be protected therein.

12. The method according to claim 11, wherein said protective film transmits less than about 1 percent incident light having a wavelength between about 300 and about 450 nm.

13. The method according to claim 12, wherein said film has a thickness in a range between about 0.5 mil and about 100 mil.

14. The method according to claim 11, wherein said UV-visible absorber selected from a group consisting of hydroxybenzophenones, benzotriazoles, cyanoacrylates, triazine, oxanilide derivatives, formamdines, cinnamates, malonate derivatives and combinations thereof.

15. The method according to claim 11, wherein said yellow dye selected from a group consisting of 3-carboxy-5-hydroxy-1-p-sulfophenyl-4-p-sulfophenylazopyrazole trisodium salt, disodium salt of 1-sulphophenylazo-2-naphthol-6-sulphonic acid, monoazo derivatives, bisazo derivatives, quinolin derivatives, xanthene derivatives and combinations thereof.

16. The method according to claim 11, wherein said plastic protective film comprises at least one material selected from the group consisting of polyvinyl chloride, polyolefins, polyesters, polyurethanes, polyamides, polysulfones, polyimides, polyetherimides, polyphenylene ethers, polyphenylene sulfides, polyether ketones, polyether ether ketones, ABS resins, polyethersulfones, poly(alkenylaromatic) polymers, polybutadiene, acrylic polymers, polyacrylonitrile, polyacetals, polycarbonates, polyphenylene ethers, ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, tetrafluoroethylene, and copolymers thereof.

17. The method according to claim 11, wherein said light absorbing compound is present at a level between 0.1 and about 5 percent by weight based on the total weight of said plastic protective film.

18. The method according to claim 11, wherein said contacting comprises applying an adhesive layer to one of said two film surfaces and thereafter joining the film to the limited use optical data storage device such that the limited use optical data storage device is in contact with said adhesive layer.

19. The method according to claim 18, wherein said adhesive layer comprises at least one adhesive material selected form the group acrylic, vinyl acrylic, styrene acrylic, urethane acrylic, butyl acrylate, acrylic emulsions, cross linked alkyl acrylic esters, rubber based adhesives selected from styrene-butadiene-styrene, epoxides, silicone based, silicone resins and combinations thereof.

20. A method of protecting a light sensitive limited-play digital versatile disc, said method comprising a first step,
Step (A) comprising obtaining a plastic protective film, said film having two film surfaces, said film comprising at least one light absorbing compound selected from the group consisting of UV-Visible absorbers and yellow dyes;
and a second step selected from the group consisting of
Step (B) contacting one of said film surfaces with the limited-play digital versatile disc to be protected thereby providing a limited use optical data storage device in contact with a removable protective film; and
Step (C) forming an enclosure comprising said protective film and inserting the limited-play digital versatile disc to be protected therein.

21. The method according to claim 20, wherein said protective film transmits less than about 1 percent incident light having a wavelength between about 300 and about 450 nm.

22. The method according to claim 20, wherein said protective film transmits less than about 1 percent incident light having a wavelength between about 315 and about 400 nm.

23. The method according to claim 21, wherein said film has a thickness in a range between about 0.5 mil and about 100 mil.

24. The method according to claim 23, wherein said film has a thickness in a range between about 0.5 mil and about 50 mil.

25. The method according to claim 20, wherein said light absorbing compound is at least one UV-visible absorber selected from the group consisting of 2-(2′-hydroxy-5′-methylphenyl)benzotriazole, 2-(3′-tert-butyl-2′-hydroxy-5′-methylphenyl)-5-chlorobenzotriazole, 2-(3′,5′-di-tert-butyl-2′-hydroxyphenyl)-5-chlorobenzotriazole, 2,2′-dihydroxy4,4′-dimethoxybenzophenone, 2-(4,6-diphenyl-1,3,5-triazin-2-yl)-5-(hexyloxy-phenol, 2-(4,6-bis(2,4-dimethylphenyl)-1,3,5-triazin-2-yl-5-octyloxy)phenol, 2-(2′-hydroxy-5′-methylphenyl)benzotriazole, 2,4-dihydroxybenzophenone, 2,4,2′,4′-tetrahydroxybenzophenone, 2-hydroxy-4-ocytyloxybenzophenone, and 2-hydroxy-4-methoxybenzophenone.

26. The method according to claim 20, wherein said light absorbing compound is at least one yellow dye selected from the group consisting of 3-carboxy-5-hydroxy-1-p-sulfophenyl-4-p-sulfophenylazopyrazole trisodium salt, disodium salt of 1-(sulphophenylazo)-2-napthol-6-sulphonic acid), monoazo derivatives, bisazo derivatives, quinoline derivatives, and xanthene derivatives.

27. The method according to claim 20, wherein said protective film is selected from the group consisting of poly(ethylene terephthalate), polycarbonate, poly(ethylene-co-vinyl alcohol).

28. The method according to claim 20, wherein said light absorbing compound is present in an amount corresponding to between about 0.5 and about 3 percent by weight based on the total weight of said plastic protective film.

29. The method according to claim 20, wherein said contacting comprises applying an adhesive layer to one of said two film surfaces and thereafter joining the film to the light sensitive limited-play digital versatile disc such that the light sensitive limited-play digital versatile disc is in contact with said adhesive layer.

30. The method according to claim 29 wherein said adhesive layer comprises at least one adhesive material selected form the group consisting of water-borne pressure sensitive adhesives, and solvent-based pressure sensitive adhesives.

31. A protected light sensitive optical article prepared by method of claim 1.

32. A protected light sensitive optical article comprising
(a) a light sensitive optical device; and
(b) a removable plastic protective layer.

33. The article according to claim 32, wherein said light sensitive optical device is an optical data storage device.

34. The article according to claim 32, wherein said light sensitive optical device is a limited play digital versatile disc.
